(19) United States
(12) Patent Application Publication
(10) Pub. No.: US 2024/0264971 A1
(43) Pub. Date: Aug. 8, 2024

(54) COMMUNICATION DEVICE, COMMUNICATION METHOD AND COMMUNICATION SYSTEM

(71) Applicant: ROHM CO., LTD., Kyoto-shi (JP)

(72) Inventor: Takuma KUDO, Kyoto-shi (JP)

(21) Appl. No.: 18/420,854

(22) Filed: Jan. 24, 2024

(30) Foreign Application Priority Data
Feb. 7, 2023 (JP) 2023-016906

(51) Int. Cl. G06F 13/42

(52) U.S. Cl. CPC G06F 13/4282

(57) ABSTRACT

The present disclosure provides a communication device configured to perform serial communication using an asynchronous serial communication. The communication device includes: a receiving unit, configured to receive a received data comprising an order of a start part including a 1-bit low data output interval, a data part started with a rising and a stop part; a measuring unit, configured to measure a pulse width in an interval including the low data output interval; and a transmitting unit, configured to transmit a transmission data at a baud rate based on a pulse width measured by the measuring unit.

### CROSS REFERENCE TO PRIOR APPLICATIONS

The present invention claims priority under 35 U.S.C. § 119 to Japanese Application No. 2023-016906, filed on Feb. 7, 2023, the entire contents of which being incorporated herein by reference.

### TECHNICAL FIELD

The present disclosure relates to a communication device, a communication method and a communication system.

### BACKGROUND

An asynchronous serial communication is available as a data communication method using serial communication. In the asynchronous serial communication, information indicating starting of a transmission data is added to a start of a data and information indicating ending of a transmission data is added to an end of a data, and the data is received and transmitted.

### PRIOR ART DOCUMENT

### Patent Publication

[Patent document 1] Japan Patent Publication No. 2007-259094

### BRIEF DESCRIPTION OF THE DRAWINGS

FIG. 1 is a timing diagram of an example of one device transmitting a data to another device in serial communication using an asynchronous serial communication of the prior art.

FIG. 2 is a diagram of an example of a solution for solving issues of the prior art.

FIG. 3A is a diagram of an example of a device receiving a received data from a universal controller.

FIG. 3B is a diagram of an example of a device transmitting a transmission data to a universal controller.

FIG. 4 is a diagram of a configuration example of a communication system according to an embodiment of the present disclosure.

FIG. 5 is a function block diagram of a device according to the embodiment.

FIG. 6 is a diagram of an operation example of a device according to the embodiment.

FIG. 7A and FIG. 7B are diagrams of examples in which a pulse width of a high data output interval and a pulse width of a low data output interval of data output from a controller are different.

FIG. 8A and FIG. 8B are diagrams of an example of a device receiving a received data from a controller according to an embodiment of the present disclosure.

FIG. 9 is a flowchart of an operation example of a device in a communication system according to the embodiment.

### DETAILED DESCRIPTION OF THE EMBODIMENTS

### Summary

A summary of several exemplary embodiments of the disclosure is given below. The summary serves as the preamble of the detailed description to be given shortly and aims to provide fundamental understanding of the embodiments by describing several concepts of one or more embodiments in brief. It should be noted that the summary is not to be construed as limitations to the breadth of the application or disclosure. The summary is not a comprehensive summary of all conceivable embodiments, nor does it intend to specify important elements of all embodiments or to define the scope of a part of or all forms. For the sake of better description, “one embodiment” sometimes refers to one embodiment (an implementation example or a variation example) or multiple embodiments (implementation examples or variation examples) disclosed in the disclosure.

A communication device according to an embodiment is a communication device that performs serial communication using an asynchronous serial communication. The communication device includes: a receiving unit, configured to receive a received data including an order of a start part including a 1-bit low data output interval, a data part started with a rising and a stop part; a measuring unit, configured to measure a pulse width in an interval including the low data output interval; and a transmitting unit, configured to transmit a transmission data at a baud rate based on a pulse width measured by the measuring unit.

According to the configuration above, a data can be transmitted and received correctly in a simpler manner in serial communication using an asynchronous serial communication.

According to an embodiment, the measuring unit can measure the pulse width of the low data output interval. The transmitting unit can transmit the transmission data at the baud rate based on the pulse width of the low data output interval measured by the measuring unit.

According to an embodiment, the transmission data can include an order of a 1-bit start part, a data part and a stop part.

According to an embodiment, the communication device can further include a read unit configured to read the received data. The data part of the received data can be configured to start with a 1-bit high data output interval. The measuring unit can measure the pulse width of the low data output interval and a pulse width of the high data output interval. The reading unit can read the received data at a baud rate based on the pulse width of the low data output interval and the pulse width of the high data output interval measured by the measuring unit.

According to an embodiment, the data part can be configured to start with a 1-bit high data output interval. The measuring unit can measure the pulse width of the low data output interval and a pulse width of the high data output interval. The transmitting unit can transmit the transmission data at the baud rate based on the pulse width of the low data output interval and the pulse width of the high data output interval measured by the measuring unit.

A communication method according to an embodiment is a communication method that performs serial communication using an asynchronous serial communication. The communication method includes: receiving a received data including a start part including a 1-bit low data output interval, a data part starting at a rising and a stop part; measuring a pulse width in an interval including the low data output interval; and transmitting a transmission data at a baud rate based on the measured pulse width.

A communication system according to an embodiment is a communication system that performs serial communication using an asynchronous serial communication. The communication system includes the communication device, and another communication device that communicates with the communication device.

### Issues

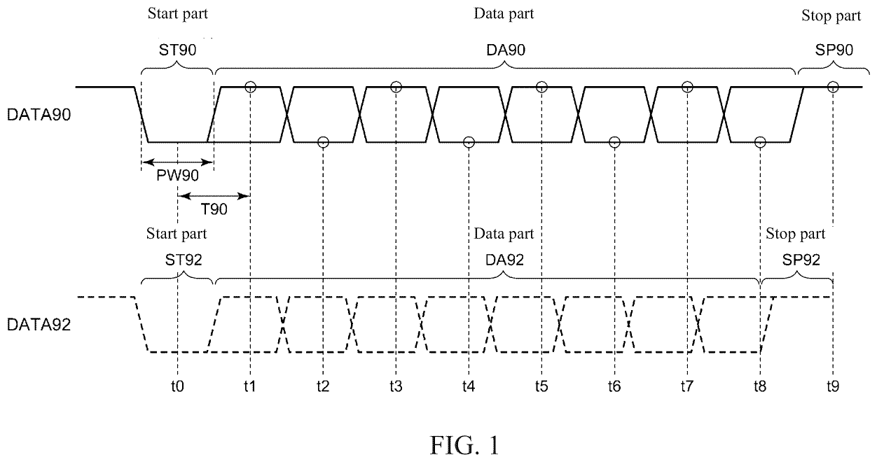

Issue of the prior art are described with reference to FIGS. 1 to FIG. 3B below. FIG. 1 shows a timing diagram of an example of one device transmitting a data to another device in serial communication using an asynchronous serial communication of the prior art. FIG. 1 depicts a data DATA90 transmitted at a predetermined baud rate and a data DATA92 transmitted at a baud rate deviated from the predetermined baud rate. As shown in FIG. 1, the data DATA90 includes an order of a start part ST90, a data part DA90 and a stop part SP90. The data DATA92 includes an order of a start part ST92, a data part DA92 and a stop part SP92.

The start part ST90 includes a 1-bit low data output interval, and the stop part SP90 includes a 1-bit high data output interval. Herein, the low data output interval is an interval in which 0 (low) data is output, and the high data output interval is an interval in which 1 (high) data is output. A pulse width PW90 of the low data output interval of the start part ST90 is predetermined to become a width corresponding to the baud rate of communication. A device on a receiving side reads respective centers of the low data output interval and the high data output interval included in the data part DA90 and the stop part SP90. More specifically, upon receiving the data DATA90, at a timing t1 at which a time T90 corresponding to the pulse width PW90 has elapsed from a timing t0 at the center of the low data output interval of the start part ST90, the device on the receiving side reads a bit at a start of the data part DA90. Then, each time a time of the pulse width PW90 has elapsed, more specifically, the device on the receiving side reads the data part DA90 and the stop part SP90 at timings t2 to t9.

However, sometimes a clock specifying a baud rate for transmission in a device on a transmitting side can be deviated, such that the baud rate for transmission is also deviated. In this case, as shown at the bottom part of FIG. 1, the data DATA92 deviated from the data DATA90 is transmitted. In this case, similar to the device on the receiving side reading the data DATA90, to read the data DATA92, the device on the receiving side reads respective centers of the high data output interval and the low data output interval of the data part DA92 and the stop part SP92 deviated from the clocks. As a result, the device on the receiving side sometimes is unable to correctly read the data part DA92 and the stop part SP92. Even if, when a clock specifying the baud rate that is deviated is generated in the device on the receiving side, the device on the receiving side is still unable to correctly read the received data.

It is considered that the frequency precision of a clock be improved in order to inhibit the inability of correctly reading data caused by such deviated clock above. However, in order to improve the frequency precision of a clock, fine-tuning of the clock and an external transistor are needed, and this increases costs

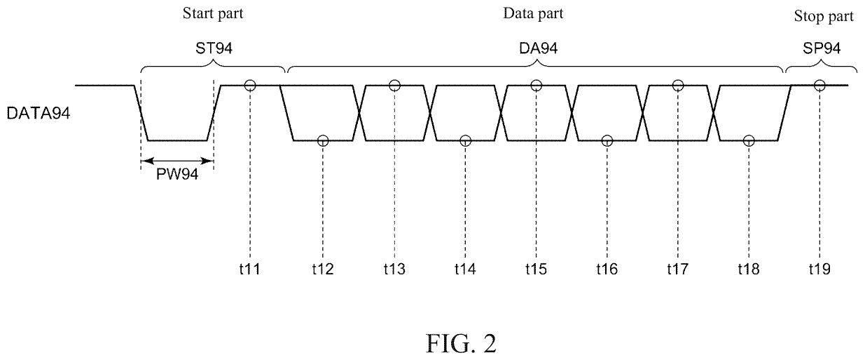

FIG. 2 shows a diagram of an example of a solution for solving issues of the prior art. FIG. 2 shows an example of a timing diagram of one device transmitting a data DATA94 to another device in serial communication using an asynchronous serial communication. The data DATA94 in FIG. 2 includes an order of a start part ST94, a data part DA94 and a stop part SP94.

The start part ST94 includes 2-bit alternating data, and more specifically, includes an order of a 1-bit low data output interval and a 1-bit high data output interval. The device on the receiving side measures a pulse width of the low data output interval of the start part ST94 and reads the data part 94 and the stop part SP94 by using the measured result. More specifically, each time a time corresponding to the measured pulse width PW94 has elapsed from the timing t11 of the center of the high data output interval of the start part ST94, the device on the receiving side reads the data part DA94 and the stop part SP94 at timings t12 to t19. Accordingly, even if the clock of the device on the transmitting side or the clock of the device on the receiving side is deviated, the device on the receiving side is still able to correctly read the data DATA94.

As such, by configuring the start part to include 2-bit alternating data, the device on the receiving side is able to correctly read data. However, in this case, malfunction is sometimes incurred when the device on the receiving side transmits a data to the device on the transmitting side.

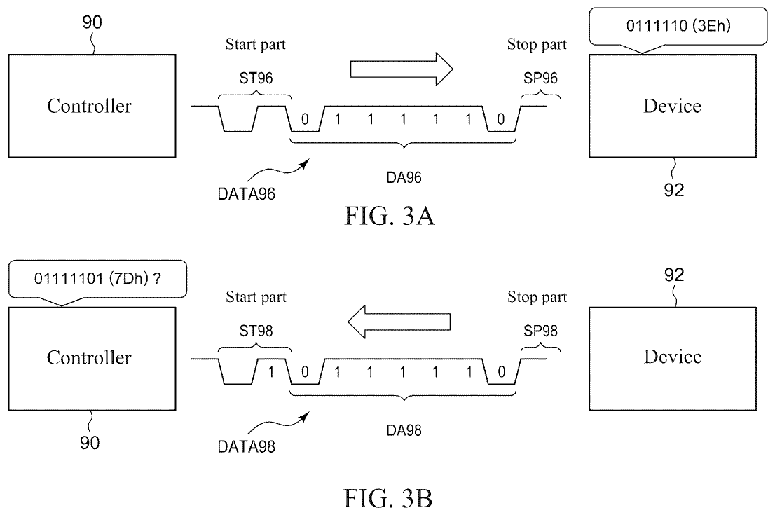

Referring to FIG. 3A and FIG. 3B, an example of the method transmitting a data with reference to FIG. 2 during serial communication using an asynchronous serial communication between two device is described. FIG. 3A shows a diagram of an example of a device 92 receiving a received data DATA96 from a universal controller 90. FIG. 3B shows a diagram of an example of a device 92 transmitting a transmission data DATA98 to the universal controller 90.

The received data DATA96 in FIG. 3A includes an order of a start part ST96, a data part DA96 and a stop part SP96. The start part ST96 includes 2-bit (1-bit low data output interval and 1-bit high data output interval) alternating data. The data part DA96 is configured as 7 bits including 0111110 (3Eh).

If the device 92 learns that the start part ST96 includes 2 bits, it can be learned that the data part DA96 includes 7 bits between the start part ST96 and the stop part SP96. The device 92 can read the data part DA96 and the stop part SP96 at a baud rate based on a pulse width of the low data output interval of the start part ST96. As a result, the device 92 reads 7 bits including 0111110 from the data part DA96.

The transmission data DATA98 in FIG. 3B includes an order of a start part ST98, a data part DA98 and a stop part SP98. Similar to the start part ST96 of the received data DATA96, the start part ST98 includes 2-bit alternating data, and the data part DA98 is configured as 7 bits including 0111110 (3Eh).

If the controller 90 is not aware that the start part ST98 includes 2 bits and is to read the data part DA98 by considering that the start part ST98 includes 1 bit, the data part DA98 cannot be correctly read. More specifically, the controller 90 reads the high data output interval at the 2nd bit of the start part ST92 as a bit with which the data part DA98 starts. As a result, the controller 90 reads 0111101 (7Dh) as information of the data part DA98. Thus, the controller 90 is unable to read the 7 bits including 0111110 transmitted from the device. Moreover, “0” as the start of the 8 bits including 01111101 read herein corresponds to “0” on the right of the data part DA98 in FIG. 3B, the 8 bits read are individually the bits of the data part DA98 arranged in an order from the right, and “1” of the start part ST98 is added at the end.

As such, if the universal controller 90 is not aware that the start part ST98 includes 2-bit alternating data, the data part DA98 included in the transmission data DATA98 cannot be read correctly. Moreover, since the baud rate at which the transmission data DATA98 transmitted by the device 92 differs based on the transmission data, the controller 90 sometimes is unaware of the baud rate of the transmission data and is thus unable to read the transmission data.

In addition, the device 92 determines a baud rate matching the transmission data DATA98 when it transmits the transmission data DATA98 to the controller 90, and thus transmits the transmission data DATA98 at the baud rate. The baud rate is different from the baud rate at which the controller 90 transmits the received data DATA96. Thus, in order to read the transmission data DATA98 transmitted at the baud rate determined by the device 92, the controller 90 needs to be set in advance.

Moreover, although the device 92 uses the pulse width of the low data output interval of the start part ST96 included in the received data DATA96, the pulse width of the high data output interval of the received data DATA96 is not taken into consideration. Thus, if the pulse width is different in the high data output interval and the low data output interval of the received data DATA96, the device 92 is sometimes unable to correctly read the received data DATA96.

### Embodiments

Details of preferred embodiments are given with the accompanying drawings below. The same or equivalent constituent elements, parts and processes in the accompanying drawings are represented by the same denotations, and repeated description is omitted as appropriate. Moreover, the embodiments are illustrative and are non-limiting to the disclosure. All features and combinations thereof described in the embodiments are not necessarily intrinsic characteristics of the disclosure.

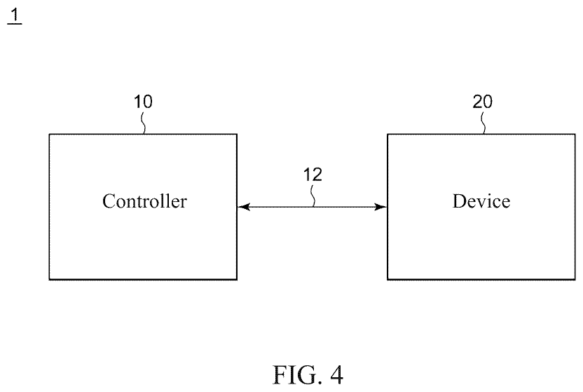

FIG. 4 shows a diagram of a configuration example of a communication system 1 according to an embodiment of the present disclosure. The communication system 1 includes a controller 10 and a device 20. The controller 10 and the device 20 are configured to be able to communicate with each other via a communication bus 12. The controller 10 and the device 20 communicate with each other by serial communication using an asynchronous serial communication. Each of the controller 10 and the device 20 can include a central processing unit (CPU), a random access memory (RAM) and a read only memory (ROM).

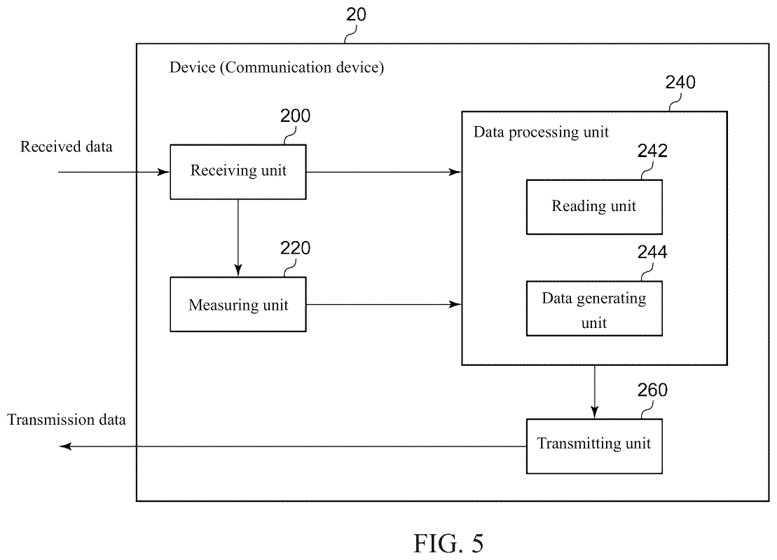

FIG. 5 shows a function block diagram of the device 20 (a communication device) according to an embodiment of the present disclosure. The device 20 includes a receiving unit 200, a measuring unit 220, a data processing unit 240 and a transmitting unit 260.

The receiving unit 200 is an interface that receives a data from an external device. For example, the receiving unit 200 is capable of receiving a received data from the controller 10. The received data includes an order of a start part, a data part and a stop part. The start part includes a 1-bit low data output interval. The data part includes multiple bits and is configured to start with a rising, and more particularly, is configured to start with a 1-bit high data output interval. The stop part can include a 1-bit high data output interval. The received data received by the receiving unit 20 is transmitted to the measuring unit 220 and the data processing unit 240.

The measuring unit 220 measures a pulse width in an interval including the low data output interval in the start part of the received data and transmits the measured result to the data processing unit 240. For example, the measuring unit 220 measures a pulse width of the 1-bit low data output interval included in the start part of the received data. Moreover, the measuring unit 220 can measure a pulse width of the 1-bit high data output interval of a start included in the data part of the received data. Moreover, the measuring unit 220 can also measure a pulse width of an interval from a falling of the start part to a falling of the start of the data part (also to be referred to as “a falling edge interval” below).

The data processing unit 240 performs various types of data processing, and more specifically, is capable of reading a received data or generating a transmission data. The function of the data processing unit 240 is implemented by collaboration of a reading unit 242 and data generating unit 244.

The reading unit 242 reads the received data and transmits a read result to the data generating unit 244. More specifically, the reading unit 242 reads the received data based on a result of the pulse width measured by the measuring unit 220. For example, the reading unit 242 can read the received data at a baud rate based on the pulse width of the low data output interval included in the start part of the receiving unit measured by the measuring unit 220. Accordingly, even if the clock of the controller 10 is deviated, the reading unit 242 is still able to perform reading at a baud rate matching the received data actually transmitted to correctly read the received data.

In addition, the reading unit 242 can read the received data at a baud rate based on the pulse width of the high data output interval of the start of the data part measured by the measuring unit 220. In addition, the reading unit 242 can read the received data at baud rates respectively based on the pulse width of the low data output interval of the start part measured by the measuring unit 220 and the pulse width of the high data output interval of the start of the data part measured by the measuring unit 220.

For example, during an interval of “0” of the data part of the received data, the reading unit 242 can perform reading at a baud rate based on the pulse width of the low data output interval of the start part measured. Moreover, during an interval of “1” of the data part of the received data, the reading unit 242 can perform reading at a baud rate based on the pulse width of the high data output interval of the start of the data part measured.

The reading unit 242 can read the received data at a baud rate based on the pulse width of the low data output interval of the start part measured by the measuring unit 220 and the pulse width of the high data output interval of the start of the data part measured by the measuring unit 220. For example, the reading unit 242 can read the received data at a baud rate based on an average time of the pulse width of the low data output interval of the start part and the pulse width of the high data output interval of the start of the data part measured by the measuring unit 220.

Moreover, the reading unit 242 can read the received data based on the falling edge interval. More specifically, the reading unit 242 can read the received data at a baud rate based on one-half of a time of a pulse width of the falling edge interval. For example, the reading unit 242 can read the received data at the baud rate in an interval in which “0” and “1” of the received data alternate.

The data generating unit 244 generates the transmission data that the device 20 transmits to an exterior and transmits the data to the transmitting unit 260. The data generating unit 244 can generate the transmission data according to a result of the received data read by the reading unit 242.

The transmission data includes an order of a start part, a data part and a stop part. The start part included in the transmission data includes a 1-bit low data output interval, and the stop part included in the transmission part includes a 1-bit high data output interval. Moreover, the data part included in the transmission data can include multiple bits, for example, 8 bits.

The transmitting unit 260 is an interface that transmits a data to an external device. For example, the transmitting unit 260 can transmit the transmission data generated by the data generating unit 244 to the controller 10.

The transmitting unit 260 can transmit the transmission data at the baud rate based on a result of the pulse width measured by the measuring unit 220. More specifically, the transmitting unit 260 can transmit the transmission data at a baud rate based on the pulse width of the low data output interval included in the stop part of the received data measured by the measuring unit 220. Moreover, the transmitting unit 260 can transmit the transmission data at a baud rate based on the pulse width of the high data output interval of the start of the data part included in the received data measured by the measuring unit 220.

In addition, the transmitting unit 260 can transmit the transmission data at baud rates respectively based on the pulse width of the low data output interval of the start part measured and the pulse width of the high data output interval of the start of the data part measured. For example, during an interval of “0” of the data part of the transmission data, the transmitting unit 260 can perform transmission at a baud rate based on the pulse width of the low data output interval of the start part measured. Moreover, during an interval of “1” of the data part of the transmission data, the transmitting unit 260 can perform transmission at a baud rate based on the pulse width of the high data output interval of the start of the data part measured.

In addition, the transmitting unit 260 can transmit the transmission data at a baud rate based on the measure result of the pulse width of the low data output interval of the stop part measured and the pulse width of the high data output interval of the start of the data part measured. More specifically, the transmitting unit 260 can transmit the transmission data at a baud rate based on an average time of the pulse width of the low data output interval of the start part measured and the pulse width of the high data output interval of the start of the data part measured.

Moreover, the transmitting unit 260 can transmit the transmission data at a baud rate based on one-half of a time of an edge width of the falling edge interval measured. For example, the transmitting unit 260 can transmit the transmission data at the baud rate in an interval in which “0” and “1” of the transmission data alternate.

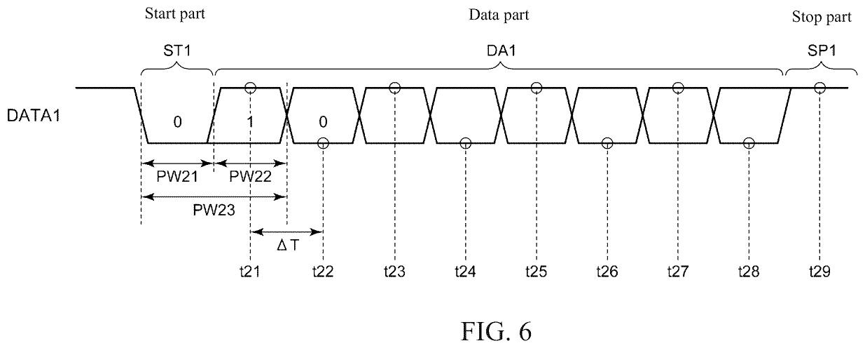

Referring to FIG. 6, an operation example of the device 20 according to the embodiment is described below. FIG. 6 depicts an example of a received data DATA1. The received data DATA1 includes an order of a start part ST1, a data part DA1 and a stop part SP1. The start part ST1 includes a 1-bit low data output interval. The data part DA1 includes 8 bits started with “10” as the first 2 bits (2 bits including an order of a 1-bit high data output interval and a 1-bit low data output interval). The measuring unit 220 can measure a pulse width PW21 of a low data output interval of the start part ST1, a pulse width PW22 of the high data output interval of the start of the data part DA1, and a pulse width PW23 of a falling edge interval.

The reading unit 242 reads the data part DA1 and the stop part SP1 at a baud rate based on a result of a pulse width measured. More specifically, the data part DA1 and the stop part SP1 can be read at a baud rate based on one-half of at least any one of a time of the pulse width PW21, the pulse width PW22 and the pulse width PW23. For example, the reading unit 242 sets a time interval ΔT as any one of one-half of the time of the pulse width PW21, the pulse width PW22 and the pulse width PW23. The reading unit 242 reads the 2nd bit of the data part DA1 at a timing t22 at which the time interval ΔT has elapsed from a timing t21 of a center of the high data output interval of the start included in the data part DA1. Then, each time the time interval ΔT has elapsed, the reading unit 242 reads the data part DA1 and the stop part SP1 at timings t23 to t29. Accordingly, the reading unit 242 is able to correctly read the data part DA1 and the stop part SP1.

Moreover, the reading unit 242 can have a different time interval for reading according to a state of a bit of the data part DA1. More specifically, during an interval of “0” of the data part DA1, the reading unit 242 can perform reading at a time interval of the pulse width PW21 measured. Moreover, during an interval of “1” of the data part DA1, the reading unit 242 can perform reading at a time interval of the pulse width PW22 measured. In addition, during an interval in which “0” and “1” of data part DA1 alternate, the reading unit 242 can perform reading at a time interval of one-half of the pulse width PW23 measured. Thus, even if the pulse width is different in the low data output interval and the high data output interval, the reading unit 242 is able to correctly read the received data.

Moreover, the transmitting unit 260 can transmit the transmission data at a baud rate based on a result of the pulse width measured. More specifically, the transmitting unit 260 can transmit the transmission data at a baud rate based on at least any one of one-half of the time of the pulse width PW21, the pulse width PW22 and the pulse width PW23 measured. For example, the transmitting unit 260 can select any one of one-half of the time of the pulse width PW21, the pulse width PW22 and the pulse width PW23 measured and transmit the transmission data in a manner of transmitting each bit at the selected time interval. Moreover, the transmitting unit 260 can have different time intervals for transmitted bits according to a state of a bit of the data part of the transmission data.

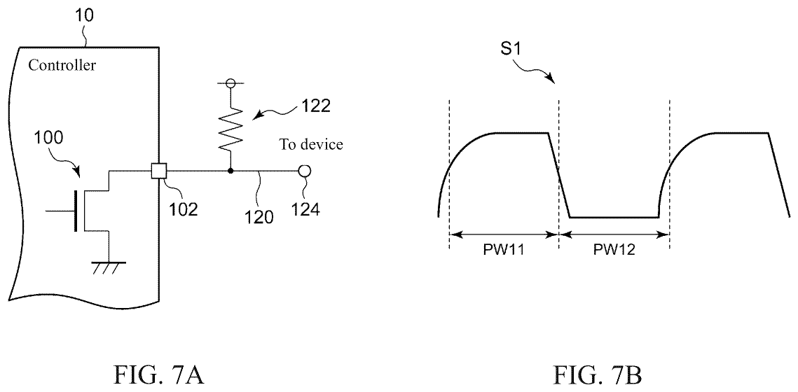

Referring to FIG. 7A and FIG. 7B, examples in which a pulse width of high data output interval and a pulse width of low data output interval of data output from a controller 10 are different are described. The controller 10 includes a transistor 100 and output port 102. The output port 102 transmits a data to the device 20 via a path 120 connected to a terminal 124 connected to the device 20 and connected to a resistor element 122. In the example in FIG. 7A, the controller 10 becomes a drain open circuit in which a drain of the transistor 100 is connected to the output port 102. In case of the drain open circuit, the pulse width is different in the high data output interval and the low data output interval.

FIG. 7B depicts an example of a data signal S1 output from the output port 102. A high data output interval PW11 and a low data output interval P12 of the data signal S1 output from the output port 102 are different from each other. In this case, compared to using a pulse width of either one of the high data output interval PW11 and the low data output interval PW12, the device 20 can use the pulse width of two intervals to more appropriately read data and transmit data.

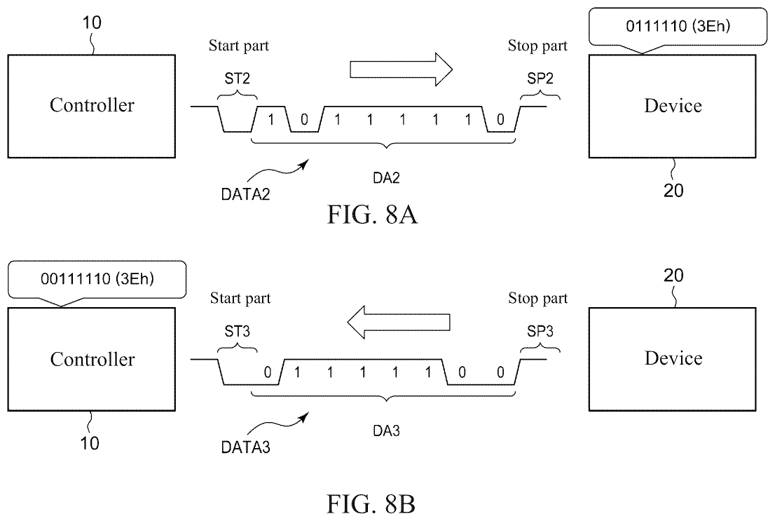

FIG. 8A shows a diagram of an example of the device 20 receiving a received data DATA2 from the controller 10 of this embodiment. The received data DATA2 includes an order of a start part ST2 including a 1-bit low data output interval, a data part DA2 configured as 8 bits including 10111110, and a stop part SP2. The device 20 can read the data part DA2 and the stop part SP2 at a baud rate based on a pulse width of the low data output interval of the start part ST2 (and a pulse width of the high data output interval of a start of the data part DA2 according to requirements). As a result, the device 20 can read 7 bits including 0111110 (3Eh) except for the 1 bit at the start of the data part DA2.

FIG. 8B shows a diagram of an example of the device 20 transmitting a transmission data DATA3 from to the controller 10 of this embodiment. The transmission data DATA3 includes an order of a start part ST3 including a 1-bit low data output interval, a data part DA3 configured as 8 bits including 00111110 (3Eh), and a stop part SP3. Herein, 00111110 are arranged from the right as the individual bits of the data part DA3 shown in FIG. 8B. In addition, the data part DA3 included in the transmission data DATA3 is different from the data part DA2 of the received data DATA2 and is not required to start with “10” as the first 2 bits but can be configured to start with “0” as this example.

At this point, since the start part ST3 of the transmission data DATA3 is formed by 1 bit as usual, the controller 10 can read the 2nd bit to the 9th bit of the transmission data as the data part DA3 as usual and can thus read 8 bits including 00111110. Moreover, the transmission data DATA3 is transmitted to the controller 10 at a baud rate based on a pulse width of a low data output interval (and a high data output interval) when the received data DATA2 is transmitted. Thus, even if the controller 10 is not specifically set, the controller 10 is able to correctly read the transmission data DATA3. Since the implementation of the controller 10 does not need to be specifically defined, a universal device can also be used as the controller 10. Moreover, in the device 20, a baud rate for transmitting and receiving a data does not need to be set in advance. As such, according to the communication system 1 of this embodiment, a data can be transmitted and received correctly in a simpler manner in serial communication using an asynchronous serial communication.

Moreover, according to this embodiment, since the start part ST2 and the start part ST3 are 1-bit, compared to a case where the start part ST94 in FIG. 2 is set to 2-bit, the data parts DA2 and DA3 in 8 bits which are 1 bit more can be transmitted and received between the controller10 and the device 20, given that the overall data amount is the same. In addition, since the device 20 of this embodiment can use a baud rate used for reception for transmission, the configuration of the device 20 needed for transmission can be simplified.

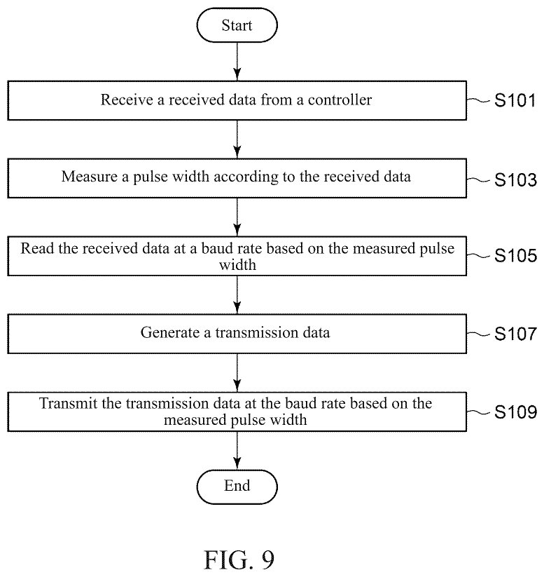

FIG. 9 shows a flowchart of an operation example of the device 20 in the communication system 1 according to an embodiment of the present disclosure. An operation example of the device 20 is described with reference to the flowchart in FIG. 9.

First, the receiving unit 220 receives a received data from the controller 10 (S101). Next, the measuring unit 220 measures a pulse width according to the received data (S103). At this point, the measuring unit 220, for example, measures a pulse width of a 1-bit low data output interval of a start part included in the received data.

Next, the reading unit 242 reads the received data at a baud rate based on the pulse width measured in step S103 (S105). Next, the data generating unit 244 generates a transmission data (S107). Next, the transmitting unit 260 transmits the transmission data at the baud rate based on the pulse width measured in step S103 (S109).

### Supplement

Although specific terms are used to describe the embodiments of the present disclosure, it is to be noted that the description provides merely examples for better understanding and are not to be construed as limitations to the present disclosure. Therefore, the scope of the present disclosure is to be interpreted in accordance with the appended claims. In addition to the embodiments above, implementations, embodiments and variations examples not described herein are also to be encompassed within the scope of the present disclosure.

### Notes

The techniques disclosed by the present application can be understood in one aspect with reference to the following.

### Item 1

A communication device, performing serial communication using an asynchronous serial communication and comprising:
a receiving unit, configured to receive a received data comprising an order of a start part including a 1-bit low data output interval, a data part started with a rising and a stop part;
a measuring unit, configured to measure a pulse width in an interval including the low data output interval; and
a transmitting unit, configured to transmit a transmission data at a baud rate based on a pulse width measured by the measuring unit.

### Item 2

The communication device according to item 1, wherein the measuring unit measures the pulse width of the low data output interval, and the transmitting unit transmits the transmission data at the baud rate based on the pulse width of the low data output interval measured by the measuring unit.

### Item 3

The communication device according to item 1 or 2, wherein the transmission data comprises an order of a 1-bit start part, a data part and a stop part.

### Item 4

The communication device according to any one of items 1 to 3, further comprising a reading unit configured to read the received data, wherein the data part of the received data is configured to start with a 1-bit high data output interval, the measuring unit measures the pulse width of the low data output interval and a pulse width of the high data output interval, and the reading unit reads the received data at a baud rate based on the pulse width of the low data output interval and the pulse width of the high data output interval measured by the measuring unit.

### Item 5

The communication device according to item 1 or 2, wherein the data part is configured to start with a 1-bit high data output interval, the measuring unit measures the pulse width of the low data output interval and the pulse width of the high data output interval, and the transmitting unit transmits the transmission data at a baud rate based on the pulse width of the low data output interval and a pulse width of the high data output interval measured by the measuring unit.

### Item 6

A communication method, performing serial communication using an asynchronous serial communication and comprising:
receiving a received data including a start part including a 1-bit low data output interval, a data part starting at a rising and a stop part;
measuring a pulse width in an interval including the low data output interval; and
transmitting a transmission data at a baud rate based on the measured pulse width.

### Item 7

A communication system, performing serial communication using an asynchronous serial communication and comprising:
the communication device of item 1; and
another communication device that communicates with the communication device.

1. A communication device, performing serial communication using an asynchronous serial communication and comprising:
a receiving unit, configured to receive a received data comprising an order of a start part including a 1-bit low data output interval, a data part started with a rising and a stop part;
a measuring unit, configured to measure a pulse width in an interval including the low data output interval; and
a transmitting unit, configured to transmit a transmission data at a baud rate based on a pulse width measured by the measuring unit.

2. The communication device of claim 1, wherein
the measuring unit is configured to measure the pulse width of the low data output interval, and
the transmitting unit is configured to transmit the transmission data at the baud rate based on the pulse width of the low data output interval measured by the measuring unit.

3. The communication device of claim 1, wherein the transmission data comprises an order of a 1-bit start part, a data part and a stop part.

4. The communication device of claim 1, further comprising a reading unit configured to read the received data, wherein
the data part of the received data is configured to start with a 1-bit high data output interval,
the measuring unit is configured to measure the pulse width of the low data output interval and a pulse width of the high data output interval, and
the reading unit is configured to read the received data at a baud rate based on the pulse width of the low data output interval and the pulse width of the high data output interval measured by the measuring unit.

5. The communication device of claim 1, wherein
the data part is configured to start with a 1-bit high data output interval,
the measuring unit is configured to measure the pulse width of the low data output interval and the pulse width of the high data output interval, and
the transmitting unit is configured to transmit the transmission data at a baud rate based on the pulse width of the low data output interval and a pulse width of the high data output interval measured by the measuring unit.

6. A communication method, performing serial communication using an asynchronous serial communication and comprising:
receiving received data including a start part including a 1-bit low data output interval, a data part starting at a rising and a stop part;
measuring a pulse width in an interval including the low data output interval; and
transmitting a transmission data at a baud rate based on the measured pulse width.

7. A communication system, performing serial communication using an asynchronous serial communication and comprising:
the communication device of claim 1; and
another communication device that communicates with the communication device.
